(19) United States
(12) Patent Application Publication
(10) Pub. No.: US 2007/0268712 A1
(43) Pub. Date: Nov. 22, 2007

(54) Automatic light emitting structure for an axle

(76) Inventor: Yuan Fa Lin, Taipei Hsien (TW)

Correspondence Address: BIRCH STEWART KOLASCH & BIRCH, PO BOX 747, FALLS CHURCH, VA, 22040-0747, US

(21) Appl. No.: 11/437,671

(22) Filed: May 22, 2006

(51) Int. Cl. B60Q 1/26

(52) U.S. Cl. 362/500

(57) ABSTRACT

An automatic light emitting structure for an axle is primarily composed of a housing, a light emitting circuit board, a small generator, and a counter weight. Upon installing the structures on the axle end, when the axle rotates, by a reaction of centrifugal force of the counter weight, a coil part of small generator will rotate at a high speed relative to a magnetic pole part to generate electricity, so as to illuminate an LED on the light emitting circuit board, thereby achieving a decoration effect of flashing without a battery or wiring.

### BACKGROUND OF THE INVENTION

a) Field of the Invention

The present invention relates to an automatic light emitting structure for an axle, and more particularly to an axle decoration structure which can generate electricity by itself to be used for its light emitting circuit. The structure is installed on an end part of axle, and it primarily uses a rotation of axle to drive a small generator to rotate for generating the electricity, such that an effect of automatically emitting the light can be achieved without a battery or wiring.

b) Description of the Prior Art

Many decorations will be installed onto an automobile by an existing owner, so as to increase a uniqueness and beauty to the vehicle. Moreover, some people will add a few light emitting decorations, so as to enable the vehicle to look fancier when driving in a night, and to allow other people to see it earlier for improving a safety in driving. Therefore, according to the aforementioned trend and requirement, it is necessary to develop more light emitting decorations for the automobiles. Accordingly, in view of the aforementioned requirement that the car lovers will enjoy decorating their cars, a brand new automatic light emitting structure for an axle is invented.

### SUMMARY OF THE INVENTION

The primary object of present invention is to provide an automatic light emitting structure for an axle, which is installed on an end part of the axle, and which uses primarily a rotation of axle to drive a small generator to rotate for generating electricity, so as to form a small decoration structure which can emit light automatically, without a battery or wiring.

Accordingly, the automatic light emitting structure for the axle of present invention comprises primarily a housing, a light emitting circuit board, a small generator, and a counter weight, wherein an upper surface of the housing is provided with a transparent window, an inner side of the housing corresponding to the transparent window is fixed with the light emitting circuit board, an off-center position on a back surface of the housing is fixed with the counter weight, and a center position on the back surface of the housing is fixed with a coil part of the small generator. A magnetic pole part of the small generator is installed as a ring in a casing seat, whereas the magnetic pole part and the coil part are pivoted and assembled, such that they can rotate relative to each other.

In assembling the aforementioned structures, the casing seat of small generator is fixed at an end position of axle (such as the axle of an automobile or a motorcycle, etc.), and when a wheel is rotating, the housing can rotate at a high speed relative to the casing seat of small generator, by a centrifugal force of the counter weight, such that an induction coil in the generator can generate electric current to illuminate an LED (Light Emitting Diode) on the light emitting circuit board, thereby achieving a decoration effect of flashing without using a battery.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows an exploded view of the present invention.

FIG. 2 shows a perspective view of the present invention.

FIG. 3 shows a cross-sectional view of the present invention.

### DETAILED DESCRIPTION OF THE PREFERRED EMBODIMENTS

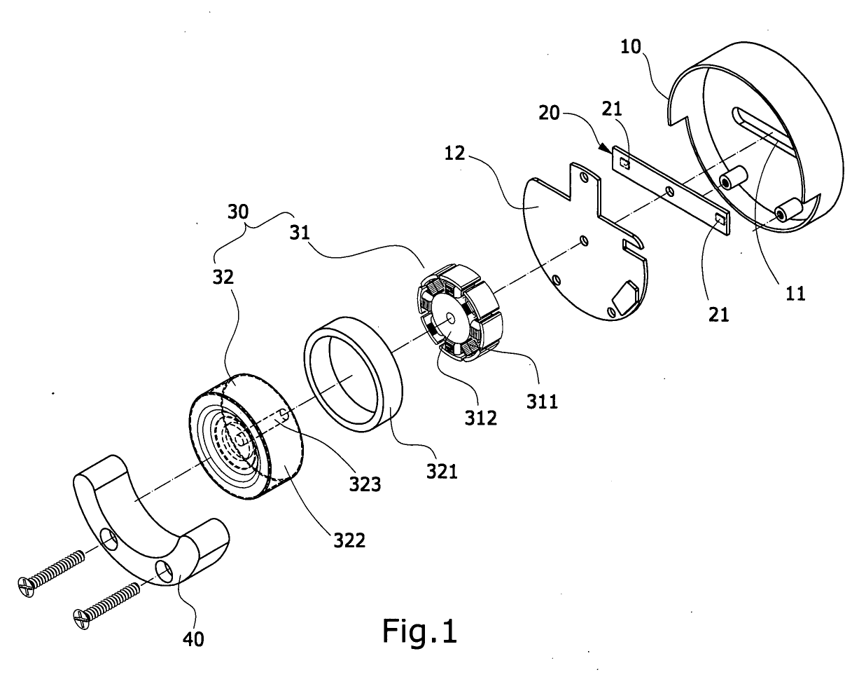

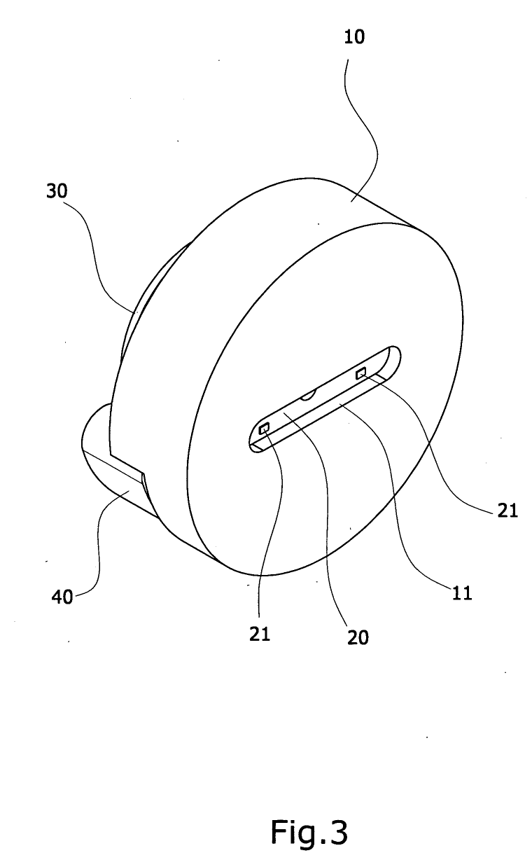

Referring to FIGS. 1 to 3, an automatic light emitting structure for an axle of the present invention is primarily composed of a housing 10, a light emitting circuit board 20, a small generator 30, and a counter weight 40. The light emitting circuit board 20 is provided with one or more than one LED (Light Emitting Diode) 21, and is connected with a power output end of the small generator 30 to form a loop. The small generator 30 includes a coil part 31 and a magnetic pole part 32, and electric current will be generated by a means of relative motion between the coil part 31 and the magnetic pole part 32.

An upper surface of the housing 10 is provided with a transparent window 11, an inner side of the housing 10 corresponding to the transparent window 11 is fixed with the light emitting diode 20, an off-center position on a back surface of the housing 10 is fixed with the counter weight 40, and a center position on the back surface of the housing 10 is fixed with the coil part 31 of small generator 30. The magnetic pole part 32 of small generator 30 is installed as a ring inside a casing seat 33, whereas the magnetic pole 31 and the coil part 31 are pivoted and assembled, such that they can rotate relative to each other.

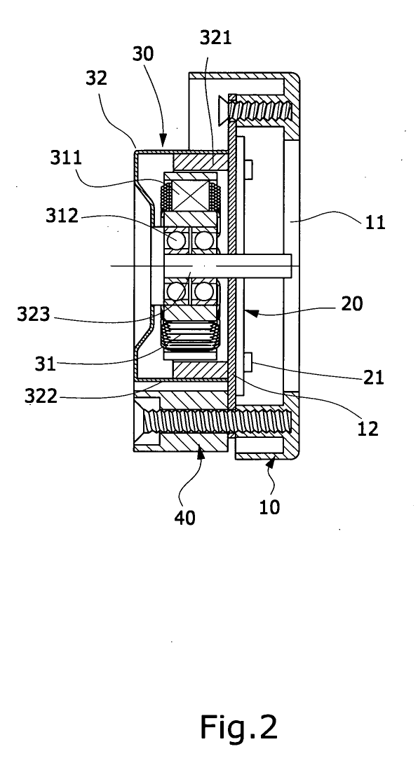

Referring to FIG. 1 and FIG. 2, a fixing board 12 is used in the housing 10 to assemble other parts. The light emitting circuit board 20 is installed on an upper surface of the fixing board 12, an inductance coil of the coil part 31 of small generator 30 is fixed at a center position on a lower surface of the aforementioned fixing board 12, and an off-center position on the lower surface of fixing board 12 is installed with the counter weight 40. The aforementioned parts are assembled together by transfixing screws into the counter weight 40, and then are assembled with the housing 10 to form a whole body, and to allow the LED 21 on the light emitting circuit board 20 to correspond to the window 11 of housing 11. In addition, a center of the inductance coil 311 of coil part 31 of small generator 30 is installed with a bearing 312, an a permanent magnet 321 of the magnetic pole part 32 is installed as a ring inside a casing seat 322, and a center of the casing seat 322 is provided with a rotary shaft 323. When assembling the coil part 31 with the magnetic pole part 32, the rotary shaft 323 at the center of casing seat 322 is inserted into the bearing 312 at the center of inductance coil 311, enabling them to be rotatable.

In assembling the aforementioned structures, the casing seat 33 of small generator 30 is fixed at an end position of axle (such as the axle of an automobile or a motorcycle, etc.) with a twin adhesive or by other adhering method, and when a wheel is rotating, the housing 10 can rotate at a high speed relative to the casing seat 33 of small generator 30, by a centrifugal force of the counter weight 40. At this time, a relative rotation in high speed will be resulted between the coil part 31 and the magnetic pole part 32, such that an induction current can be generated between the inductance coil 311 and the permanent magnet 321, in order to be used by the LED 21 on the light emitting circuit board 20 to illuminate, thereby being able to be used without using a battery or connecting to a power cord of an automobile (or a motorcycle).

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. An automatic light emitting structure for an axle including a housing, a light emitting circuit board, a small generator, and a counter weight, wherein an upper surface of the housing is provided with a transparent window, an inner side of the housing corresponding to the transparent window is fixed with the light emitting circuit board, an off-center position on a back surface of housing is fixed with the counter weight, and a center position on the back surface of housing is fixed with a coil part of the small generator; a magnetic pole part of the small generator being installed as a ring inside a casing seat, whereas the magnetic pole part and the coil part being pivoted and assembled, such that they can rotate relative to each other.

2. The automatic light emitting structure for an axle according to claim 1, wherein a fixing board is used in the housing to assemble the light emitting circuit board, the small generator, and the counter weight; the light emitting circuit board being installed on an upper surface of the fixing board, an inductance coil of coil part of the small generator being fixed at a center position on a lower surface of the aforementioned fixing board, and the counter weight being installed at an off-center position on the lower surface of fixing board, and then these structures being assembled with the housing to form a whole body, after being assembled according to the aforementioned descriptions.

3. The automatic light emitting structure for an axle according to claim 1, wherein the inductance coil of coil part of the small generator is fixed at a center position on a back surface of the housing, its center is provided with a bearing, a permanent magnet of the magnetic pole part of small generator is installed as a ring inside a casing seat, and a center of the casing seat is provided with a rotary shaft which is pivoted in the bearing at the center of inductance coil to rotate.
